(19) United States
(12) Patent Application Publication
(10) Pub. No.: US 2023/0294581 A1
(43) Pub. Date: Sep. 21, 2023

(54) ARMREST OPENING AND CLOSING DEVICE FOR VEHICLE

(71) Applicant: SHINKI INTER-MOBIL CO., LTD., Busan (KR)

(72) Inventors: Kyoung Sik KIM, Ansan-si (KR); Sang Jin JOUNG, Ulsan (KR); Hong Kil NOH, Asan-si (KR)

(21) Appl. No.: 17/848,977

(22) Filed: Jun. 24, 2022

(30) Foreign Application Priority Data
Mar. 15, 2022 (KR) 10-2022-0031877

(51) Int. Cl. B60N 2/75

(52) U.S. Cl. CPC B60N 2/793

(57) ABSTRACT

Disclosed herein is an opening and closing device smoothly performing initial opening of an armrest. The device includes an armrest (A) mounted on an upper portion of a storage box (S). The armrest includes a pair of side lids (20) and a center lid (10). A push member (50) is mounted on the inner face of the side lid to be vertically movable, and is supported upward elastically by an elastic member, and push the center lid upward. The side lid includes an outer cover (22) and an inner cover (24). A part of a metal frame (40) is mounted between the outer cover and the inner cover.

### CROSS-REFERENCE TO REPLATED APPLICATIONS

The present application is based upon and claims the benefit of priority to Korean Patent Application No. 10-2022-0031877 filed on Mar. 15, 2022, in the Korean Intellectual Property Office, which is incorporated herein by reference in its entirety.

### BACKGROUND OF THE INVENTION

### Field of the Invention

The present invention relates to an armrest opening and closing device for a vehicle, and more specifically, to an armrest opening and closing device for a vehicle, which can effectively raise a cover to a certain section at the time of initial opening when the cover is unlocked to selectively open and close the cover of the armrest at the front or at the rear.

### Background Art

A console is installed between a driver seat and a passenger seat of a vehicle. Such a console includes a storage box mounted at a lower part and an armrest for opening and closing the upper portion of the storage box. Moreover, the armrest includes side lids fixed to both sides of the storage box located at the lower part, and a center lid mounted between the side lids to be opened and closed.

Therefore, in substance, the center lid of the armrest opens and closes a storage room inside the storage box. Traditionally, the armrest is configured to be opened unidirectionally from the front to the rear. However, by various requests, Korean Utility Model Application No. 20-1994-0031556 (filed on Nov. 28, 1994) and Korean Patent Application No. 10-2004-0097620 (filed on Nov. 25, 2004) proposed armrest configured to be selectively opened from the front or the rear.

Besides the above, recently, products capable of being selectively opened and closed on both sides have been disclosed. However, such conventional arts are complicated in structure and it is difficult to implement realistically. In addition, in the case that the armrest is selectively opened or closed at the front or rear, there is no countermeasures for various disadvantages that could happen in the actual use.

### SUMMARY OF THE INVENTION

Accordingly, the present invention has been made in view of the above-mentioned problems occurring in the prior art, and it is an object of the present invention to provide an armrest opening and closing device which can perform initial opening in the most effective way by an elastic member when the center lid of the armrest is selectively opened and closed forward or backward.

The opening and closing device according to the present invention is applicable to various structures to bidirectionally open and close an armrest. That is, the opening and closing device according to the present invention is applicable not only to bidirectional opening and closing structures of conventional arts or currently commercialized armrests but also to all structures which can selectively open and close an armrest in the back-and-forth direction or bidirectionally.

According to an armrest opening and closing device for a vehicle of the present invention, an armrest is installed on an upper portion of a storage box having an open upper portion. The armrest which opens and closes the storage box includes a pair of side lids fixed and supported on the upper portion of the storage box and a center lid mounted at the center of the side lid to be opened and closed in the back-and-forth direction with respect to the side lids. Here, a push member is mounted on the inner face of the middle portion of the side lid to be vertically movable, and is supported elastically upward by an elastic member to push the center lid upward.

According to another embodiment of the present invention, the side lid includes an outer cover, an inner cover, and a metal frame interposed between the outer cover and the inner cover to couple and support the outer cover and the inner cover, and the push member is supported by the inner cover to be vertically movable.

According to another embodiment of the present invention, the frame includes a lower frame fixed to the storage box, and an upper frame extending upward from the lower frame and locating between the outer cover and the inner cover to support the outer cover and the inner cover.

According to the present invention, the push member is mounted in the middle portion of the side lid to be vertically movable, and is pressed upward by the elastic member. Therefore, when the coupling of the center lid of the armrest is released, the center lid is pushed upward, thereby sufficiently providing the initial opening function that the center lid is lifted at a predetermined interval.

According to the initial opening by the push member, in the case that the center lid is configured to be opened and closed bidirectionally, because the center lid can be pushed bidirectionally to be lifted upward, the present invention can be configured more simply and effectively. Additionally, the frame made of a metallic material can sufficiently reinforce the structural strength between the storage box and the armrest.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view illustrating a console to which an armrest opening and closing device for a vehicle according to the present invention is applied;

FIG. 2 is a view illustrating initial opening of the armrest opening and closing device for a vehicle according to the present invention;

FIG. 3 is a perspective view illustrating the armrest opening and closing device for a vehicle according to the present invention; and

FIG. 4 is a perspective view illustrating essential parts of the armrest opening and closing device for a vehicle according to the present invention.

### DETAILED DESCRIPTION OF THE PREFERRED EMBODIMENT

Hereinafter, the present invention will be described in more detail with reference to the embodiment illustrated in the drawings.

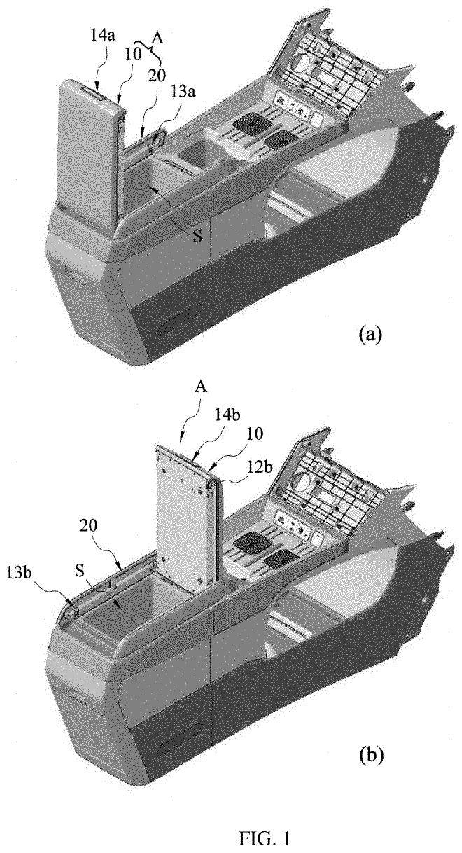

A console in a vehicle includes: a storage box S which can be referred to as a storage space; and an armrest A for opening and closing an open portion of the upper end of the storage box. Furthermore, as illustrated in FIG. 1, the armrest A according to the present invention includes: a center lid 10 for opening and closing a storage space; and a pair of side lids 20 fixed to an upper portion of the storage box S to support the opening and closing of the center lid 10. The armrest A is installed on the top of the storage box S and is used to open and close the storage space of the storage box S.

The opening and closing device according to the present invention is applied to the armrest A of the console, and more specifically, is applied to the center lid 10 of the console A which is opened and closed bidirectionally, but the present invention is not limited thereto. FIG. 1(a) illustrates the center lid 10 opened backward, and FIG. 1(b) illustrates the center lid 10 opened forward. Here, to be selectively opened and closed forward and backward substantially means to be selectively opened and closed bidirectionally.

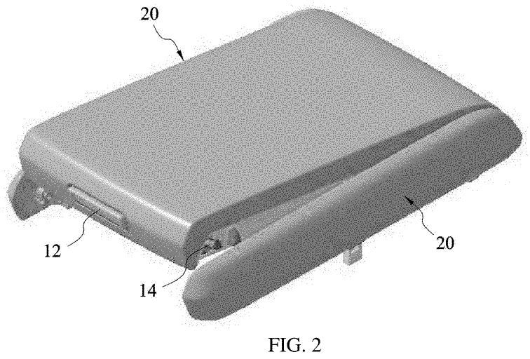

The opening and closing structure according to the present invention can use the bidirectional opening and closing structure disclosed in the preceding patent document described above, and can be applied to any structure for the bidirectional opening and closing of the center lid 10. The armrest maintains its locked state in which the armrest is not opened without external force, namely, external manipulation, in the locked state due to a locking device. Moreover, the initial opening of the armrest, as illustrated in FIG. 2, means that a certain section of the center lid 10 is opened by elastic restoring force of a built-in elastic member when the release button 12 is pressed down to release the locked state.

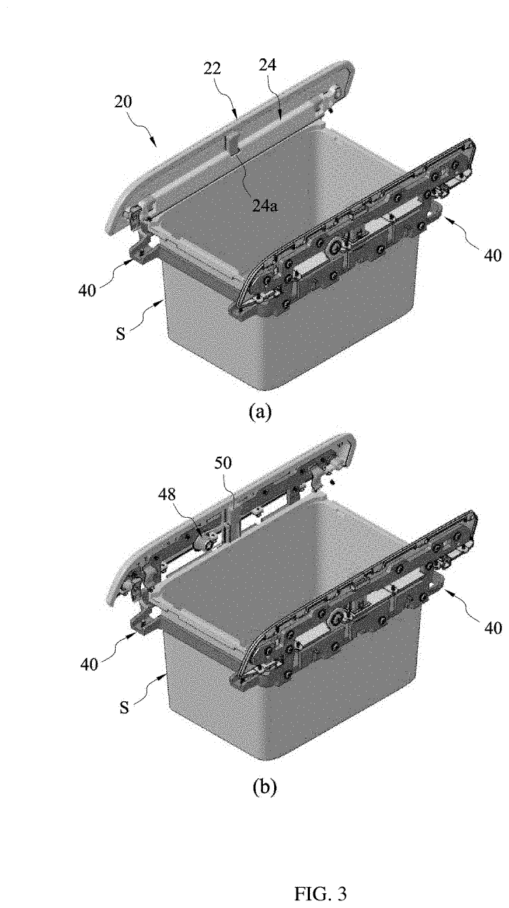

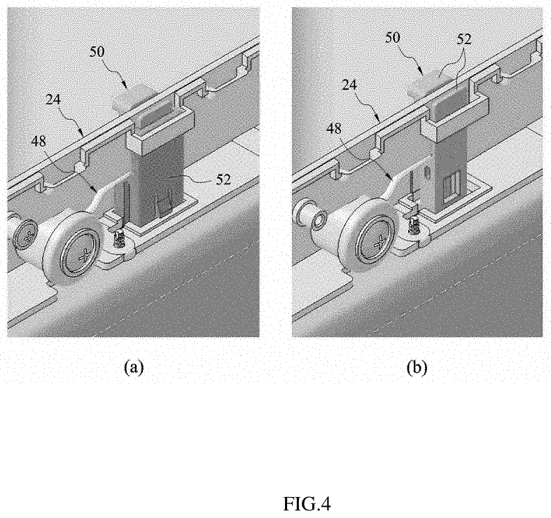

In the case that the center lid 10 is configured to be opened and closed bidirectionally, when release buttons 12 respectively mounted at front and rear ends of the center lid 10 are pressed selectively, a certain section of the center lid 10 is opened while the locked state of the front and rear end portions of the center lid 10 is released as illustrated in FIG. 2. Next, referring to FIGS. 3 and 4, the opening and closing device according to the present invention, namely, a specific configuration for the initial opening at the time of the bidirectional opening and closing will be described.

Releasing the locked state means, for instance, that the hinge shaft 14 mounted at both sides of the end of the center lid 10 gets out of a support hole (not shown) formed in a corresponding portion of the side lid 20 to release the locked state. FIG. 2 illustrates the locked state, and there may be various embodiments of the locked state between the center lid 10 and the side lid 20 and structures to release the locked state.

As illustrated in FIG. 3, each of the side lids 20 includes an outer cover 22 and an inner cover 24. The frame 40 of a metal material supports the storage box S and the side lid 20 by connecting the storage box S and the side lid 20. That is, the frame 40 includes a lower frame 42 fixed to the storage box S, and an upper frame 44 extending upward from the lower frame 42 and supporting the side lid 20.

In addition, the outer cover 22 and the inner cover 24 are fixed and supported on the upper frame 44 mounted therebetween, for example, by bolts or the likes. Therefore, the upper frame 44 is also one element constituting the side lid 20. The entire of the frame 40 is preferably made of aluminum diecasting. As such, the upper frame 44 supports the side lids 20 of both sides.

Furthermore, according to the present invention, the side lid 20 includes a push member 50 supported upward by an elastic member, such as a spring. The push member 50 is to push the center lid 10 upward to a predetermined height when the release button 12 is pushed to release the locked state in the state in which the center lid 10 of the armrest is closed to be locked, and is mounted in the middle portion of the side lid 20.

That is, the push member 50 is mounted in the middle of the side lid 20, and the side lid 20 receives elastic force upwards by a spring. Therefore, when the locking force which closes the center lid 10 is removed, the push member 50 lifts the center lid 10 slightly upward, and it is called ‘initial opening’.

In the present invention, the push member 50 is mounted in the middle portion of the side lid 20 so as to be equally applicable to the bidirectional opening and closing of the center lid. Since the center lid 10 is closed to maintain the locked state, the push member may use a member mounted on the side lid 20 or may be fastened and fixed at another portion of the armrest.

As illustrated in FIG. 3(a), because the push member 50 is supported to be vertically movable in a state in which the push member protrudes inward through a through hole 24a formed in the inner cover 24, the push member is configured to push up the center lid 10 opened and closed between both side lids 20. Moreover, as illustrated in FIG. 4, the push member 50 is pressed upward by the elastic member 48, which is a torsion spring in the drawing.

The push member 50 is supported to be movable in the vertical direction on the inner cover 24. For example, the push member 50 is supported to linearly move in the vertical direction by a guide 52 having a vertically tubular shape mounted on the inner cover 24. In addition, it would be easily understood by those skilled in the art that there are various embodiments of the push member 50, which is guided to move vertically by the inner cover 24.

In the embodiment illustrated in the drawings, an end portion of a torsion spring 48 is configured to push the push member 50 upward, but the present invention is not limited thereto, and it is natural to elastically support the push member 50 upward using the elastic force of various types of the spring. As described above, the push member 50 is mounted on the side lid 20 to be movable in the vertical direction and is elastically supported upward by the elastic member.

As illustrated in FIG. 4, the upper portion of the push member 50 according to the present invention has a bisected pork-shaped portion 52. A groove formed in the middle of the pork-shaped portion 52 is opened at the top. The pork-shaped portion 52 is coupled from bottom to top with respect to the inner cover 24. Therefore, the pork-shaped portion 52 is configured to stop at a predetermined height with respect to upward elastic force of the torsion spring 48.

According to an embodiment of the present invention, the inner cover 24 is supported by an upper frame 44. Here, the frame 40 includes the lower frame 42, which has a rectangular shape when viewed on the plane figure and is supported on the storage box S. Furthermore, the inner cover 24 and the outer cover 22 are respectively fixed to the inner side and the outer side of the upper frame 44 by bolts or the likes. The lower frame 44 is fastened to the storage box S by using a fastening (fixing) element, such as, a bolt.

The lower frame 44 made of aluminum diecasting has a substantially rectangular shape and is supported on the outer surface of the storage box S while being in close contact with the outer surface of the storage box S. The upper frame 44 functions to support the outer cover 22 and the inner cover 24 while forming a part of the side lid 20. Here, the frame 40 has sufficient structural strength since being formed of a metal material, thereby sufficiently and firmly supporting the armrest (center lid) opened and closed with respect to the fixed storage box S.

As described above, the present invention can sufficiently perform the initial opening of the center lid of the armrest since the push member is mounted in the middle of the side lid. Additionally, peripheral units of the push member according to the present invention can be used more usefully when the armrest is configured to be opened and closed bidirectionally. In addition, it would be easily understood that the frame 40 according to the present invention can strongly support the inner cover 24 of the side lid 20 and sufficiently reinforce the structural strength of the entire console.

What is claimed is:

1. An armrest opening and closing device for a vehicle comprising:
a storage box having an open upper portion;
an armrest which is mounted at the upper portion of the storage box to be opened and closed, and has a pair of side lids fixed and supported on the upper portion of the storage box and a center lid mounted at the center of the side lid to be opened and closed in the back-and-forth direction with respect to the side lids; and
a push member mounted on the inner face of the middle portion of the side lid to be vertically movable, supported elastically upward by an elastic member to push the center lid upward.

2. The armrest opening and closing device according to claim 1, wherein the side lid comprises an outer cover, an inner cover, and a metal frame interposed between the outer cover and the inner cover to couple and support the outer cover and the inner cover, and the push member is supported by the inner cover to be vertically movable.

3. The armrest opening and closing device according to claim 2, wherein the frame comprises a lower frame fixed to the storage box, and an upper frame extending upward from the lower frame and locating between the outer cover and the inner cover to support the outer cover and the inner cover.
